(19) United States
(12) Patent Application Publication
(10) Pub. No.: US 2011/0161891 A1
(43) Pub. Date: Jun. 30, 2011

(54) INFORMATION PROCESSING APPARATUS AND INFORMATION PROCESSING METHOD

(76) Inventors: Tomoyuki Shimaya, Fuchu-shi (JP); Noriaki Kawai, Fussa-shi (JP); Shingo Kikukawa, Ome-shi (JP); Taichiro Yamanaka, Hachioji-shi (JP); Tetsuya Akiyama, Higashikurume-shi (JP); Takahisa Kaihotsu, Musashino-shi (JP)

(21) Appl. No.: 12/975,032

(22) Filed: Dec. 21, 2010

(30) Foreign Application Priority Data
Dec. 25, 2009 (JP) 2009-295635

(51) Int. Cl. G06F 3/033; G06F 3/041

(52) U.S. Cl. 715/863; 345/173

(57) ABSTRACT

According to one embodiment, the relationship between respective fingers of a user and corresponding screens is registered, a screen and command are determined according to the motion (motion trajectory) of a finger that touches a touch input device and the type of the finger, and a multi-screen is operated.

### CROSS-REFERENCE TO RELATED APPLICATIONS

This application is based upon and claims the benefit of priority from Japanese Patent Application No. 2009-295635, filed Dec. 25, 2009; the entire contents of which are incorporated herein by reference.

### FIELD

Embodiments described herein relate generally to an information processing apparatus of a television receiver or the like capable of displaying a multi-screen.

### BACKGROUND

Recently, in large-scale television receivers or the like, television receivers utilizing multi-screen systems are widely used. In the multi-screen system, the screen of the television can be divided into two portions and programs of different broadcasting channels can be displayed on the two divided screens. The channel of the program displayed on each divided screen can be individually set by use of a remote controller or the like. If a television receiver contains a terrestrial digital tuner, BS digital tuner, CS digital tuner or the like and an external HDD recorder or the like is connected thereto, images from the respective devices can be freely set and displayed on the divided screens.

For example, a voice of the program displayed on one of the two divided screens is generated from the speaker of the television and it is possible to hear a voice of the program displayed on the other divided screen by use of an earphone. Therefore, two or more viewers can view different programs simultaneously displayed on one television. Further, as another utilization method, a main screen having a voice generated from a speaker and a sub-screen of a program on a different channel having no voice generated can be set on the television of the multi-screen system. Since it is easy to switch the main image and sub-image, the viewer can view a desired scene in the program on the different channel without missing.

When the television is set in a multi-screen mode and the multi-screen is operated, a desired screen that is first operated is selected and then various screen operations such as a channel switching operation are performed. When the screen operations are performed, a touch panel may be used in some cases. The touch panels are used as input devices of various devices such as ticket-vending machines of stations, ATMs of banks and the like.

As described before, when the multi-screen of the television is operated, a screen that is desired to be operated is first selected and then various screen operations such as the channel switching operation are performed. However, with the above procedure, there occurs a problem that the operation is complicated.

In the related art case, a command may be registered in relation to a finger of the operator or a combination of fingers. It is determined which one of the fingers of the operator touches the touch panel. Based on the above determination result, one of the registered commands is selected and a process corresponding to the command is performed.

Thus, in the related art, the operator must memorize the fingers to which the commands are respectively set. Therefore, even if the above related art technique is applied to the operation of the multi-screen of the television, simplification of the operation and enhancement of easiness cannot be realized.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is a block diagram showing a digital broadcasting television as one example of an information processing apparatus to which this invention is applied.

FIG. 2 is a block diagram showing the detailed portions of a screen operation unit and remote controller of FIG. 1.

FIG. 3 is a diagram showing the details of the storage content of a finger/screen correspondence database.

FIG. 4 is a view showing one example of a multi-screen of a television.

FIG. 5 is a view showing another example of the multi-screen of the television.

FIG. 6 is a view showing an example of the multi-screen in which the frame of a selected screen is displayed thick.

FIG. 7 is a diagram showing a first embodiment of the concrete operation of a screen operation process according to this invention.

FIG. 8 is a diagram showing a second embodiment of the concrete operation of the screen operation process according to this invention.

### DETAILED DESCRIPTION

Various embodiments according to the invention will be described hereinafter. In one embodiment of this invention, the relationship between respective fingers of a user and corresponding screens is registered, a screen and command are determined according to the motion (motion trajectory) of a finger that touches a touch input device and the type of the finger, and a multi-screen is operated. In general, according to one embodiment of the invention, there is provided an information processing apparatus including a touch input unit 100 configured to detect the position of a touch portion with a finger, a storage unit 300 configured to store a trajectory of the touch portion that moves, a determination unit 320 configured to determine a command corresponding to the trajectory, a determination unit 210 configured to determine a type of a finger that touches the touch input unit 100, a finger/screen correspondence database 410 in which ones of divided screens are set in correspondence to the respective fingers, a decision unit 400 configured to search the database and decide a screen that corresponds to the type of the finger determined by the determination unit, a control unit 15 configured to control display of the respective ones of the divided screens according to an input control signal, and a transmission unit 500 configured to add information of the screen decided by the decision unit 400 to the command determined by the determination unit 210 and transmit the result as the control signal to the control unit 15.

Now, one embodiment of the information processing apparatus according to this invention is explained with reference to the accompanying drawings.

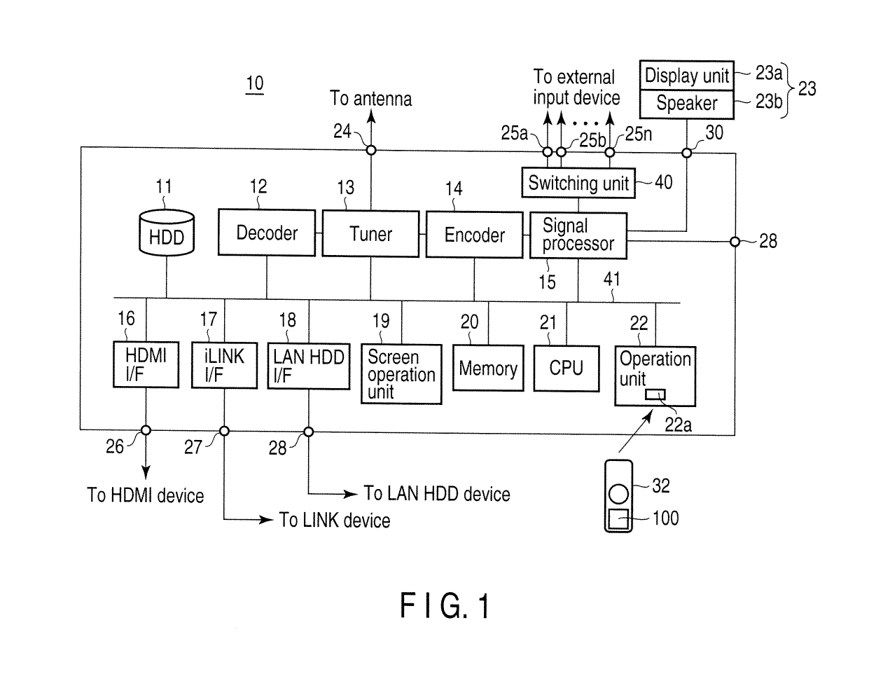

FIG. 1 is a block diagram showing a digital broadcasting television 10 as one example of the information processing apparatus to which this invention is applied.

A broadcasting signal received by an antenna is received by a tuner 13 via an antenna input terminal 24. The tuner 13 extracts program data of a specified channel from the received broadcasting signal. The tuner 13 includes a plurality of digital tuners that can receive digital broadcasts such as a BS digital broadcast and terrestrial digital broadcast.

An HDMI I/F 16 functions as an interface with an HDMI device connected to an HDMI terminal 26. An IEEE1394 (iLINK) I/F 17 functions as an interface with an IEEE1394 device connected via an IEEE1394 terminal 27. A LAN HDD I/F 18 functions as an interface with a LAN HDD device connected via a terminal 28. A decoder 12 decodes (expands) compressed data supplied from the tuner 13, various interfaces 16 to 18 or HDD 11.

A signal processor 15 subjects image data and voice data decoded by means of the decoder 12 to D/A conversion and amplification, for example, to play back an image signal and voice signal. A monitor unit 23 displays an image based on the image signal supplied from the signal processor 15 via a terminal 30 and outputs a voice based on the voice signal. When a multi-screen mode signal is input, the signal processor 15 divides the screen of a display unit 23a and displays program images on a plurality of screens. Further, when a plurality of screens are displayed on the display unit 23a in the multi-screen mode, the signal processor 15 can freely set program voices output to the terminals 30 and 28 according to an input control signal.

A switching unit 40 selects one of external input devices (analog video devices) connected thereto via external input terminals 25a, . . . , 25n under control of a CPU 21 and supplies an analog signal from the selected external input device to the signal processor 15. The signal processor 15 subjects the input analog signal from the external input device to a signal processing operation such as an amplification process and filtering process and supplies the thus processed signal to the monitor unit 23. When an analog signal from the external input device is recorded, for example, the analog signal is A/D-converted by the signal processor 15, encoded (compressed) by an encoder 14 and recorded on the HDD 11. Further, the HDD 11 records encoded image and voice data provided from the interfaces 16 to 18.

An operation unit 22 is a user interface and includes various buttons that perform various input operations by the user and a receiver 22a that receives a signal transmitted from a remote controller 32. The user can operate the television 10 by use of the operation unit 22 or remote controller 32.

A memory 20 includes a ROM that stores various control programs and a RAM used as a work area of the CPU 21. The CPU 21 executes the control program stored in the memory 20 according to an instruction input via the operation unit 22 by the user.

A screen operation unit 19 receives a touch input signal of the user input from a touch input unit 100 of the remote controller 32 via the operation unit 22 and performs a multi-screen operation according to one embodiment of this invention. The screen operation unit 19 may be stored in the memory 20 as a program executed by the CPU 21.

Next, the screen operation process of the screen operation unit 19 according to one embodiment of this invention is explained.

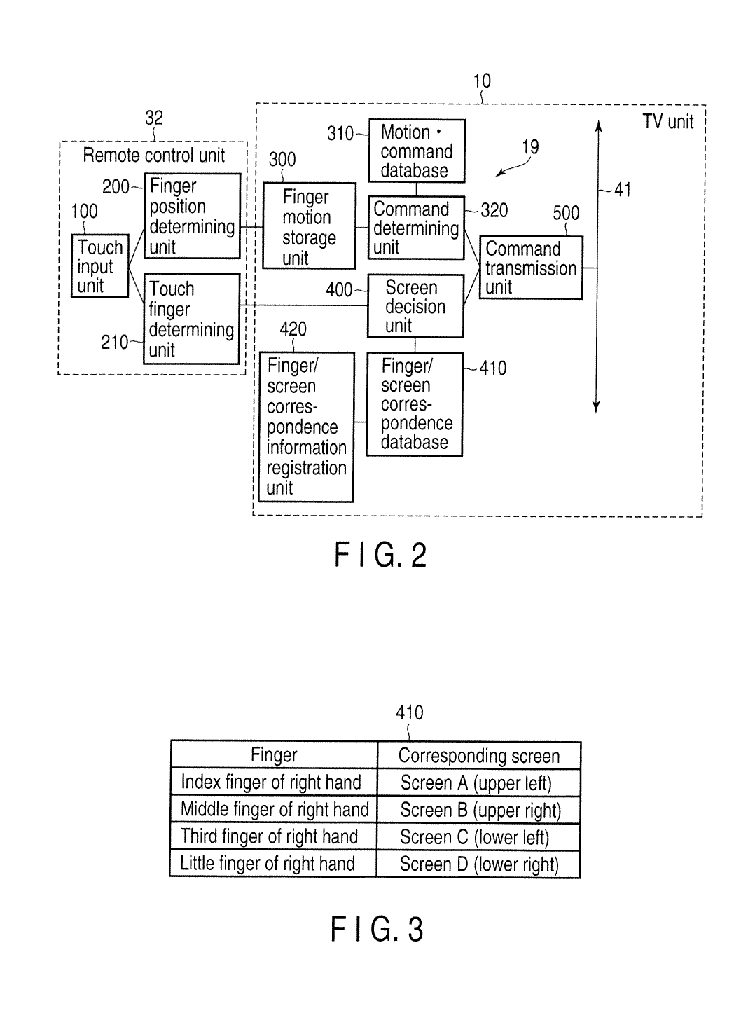

FIG. 2 is a block diagram showing the detailed portions of the screen operation unit 19 and remote controller 32.

Information indicating that the finger of the user touches the touch input unit 100 (touch pad, touch panel, touch screen or the like) is transmitted to a finger position determination unit 200 and touch finger determination unit 210. The finger position determination unit 200 determines a position of the touch input unit 100 which the finger touches. A trajectory along which the finger touching position moves is stored in a finger motion storage unit 300. In a motion•command database 310, a list of commands corresponding to respective motions is stored. For example, a motion of vertically moving the finger when it is desired to change channels and a motion of horizontally moving the finger when inputs are changed may be considered. The command determination unit 320 decides a command corresponding to the motion based on the motion•command database 310 and information of the finger motion storage unit 300. The touch finger determination unit 210 determines a finger that touches and generates a signal indicating the type of the finger (index finger, middle finger or the like). In a finger/screen correspondence database 410, a list of screens that respectively correspond to the fingers is stored. The screen decision unit 400 decides a screen to which the command is to be transmitted based on a signal indicating the type of a finger from the touch finger determination unit 210 and the finger/screen correspondence database 410. A finger/screen correspondence information registration unit 420 has a function of registering the correspondence relationship between the fingers and the screens. In the finger/screen correspondence database 410, default values are previously stored, but the finger/screen correspondence relationship can be changed based on a signal from the remote controller 32 by means of the finger/screen correspondence information registration unit 420.

A command transmission unit 500 transmits a command having screen information added to the decided command to the signal processor 15. The signal processor 15 controls the respective screens in response to a command with screen information.

FIG. 3 is a diagram showing the details of the storage content of the finger/screen correspondence database 410. Each finger and a corresponding screen that make a set are stored. The user can change the storage content by means of the finger/screen correspondence information registration unit 420 as described before.

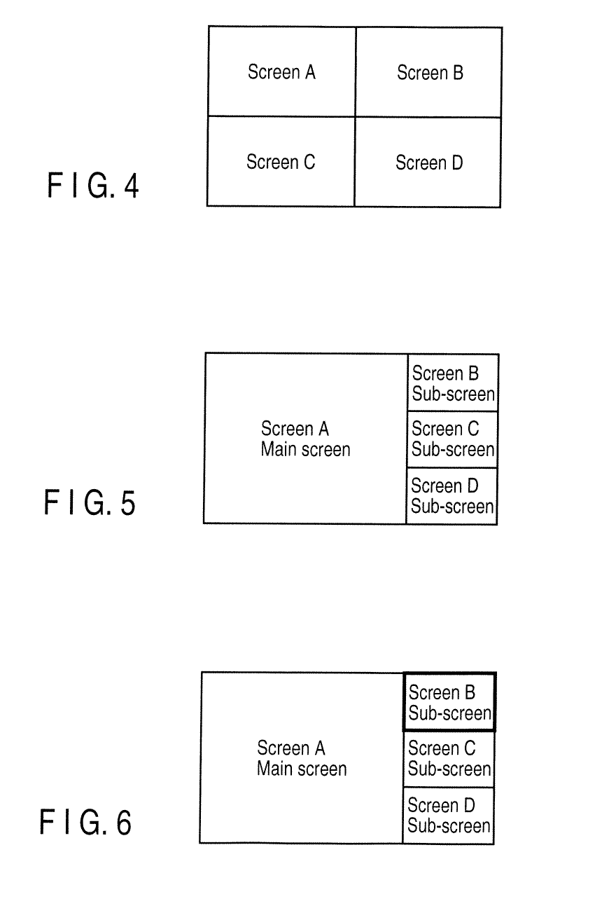

FIG. 4 shows one example of a multi-screen of the television. The division layout of the multi-screen coincides with information of “corresponding screen” of the finger/screen correspondence database of FIG. 3. On the multi-screen, for example, one or more program images of terrestrial digital broadcasting and BS digital broadcasting and (or) an image from a video device connected to the apparatus can be freely displayed according to an instruction from the remote controller 32.

FIG. 5 shows another example of the multi-screen of the television. For example, it is assumed that it is desired to replace a program displayed on a screen B of a sub-screen by a program displayed on a screen A of a main screen. Since the fingers are set to correspond to the respective screens, the displayed program on the screen B of the sub-screen and the displayed program on the screen A of the main screen are exchanged if a finger corresponding to the screen B (a middle finger in the example of the finger/screen correspondence database of FIG. 3) moves round on the touch input 100. That is, the main and sub are exchanged. The turning operation is given as one example and another operation may be registered in the motion•command database 310.

The multi-screen shown in FIG. 6 permits the user to easily understand that a screen corresponding to the finger is selected by displaying the frame of the screen thick when the screen corresponding to the finger is selected.

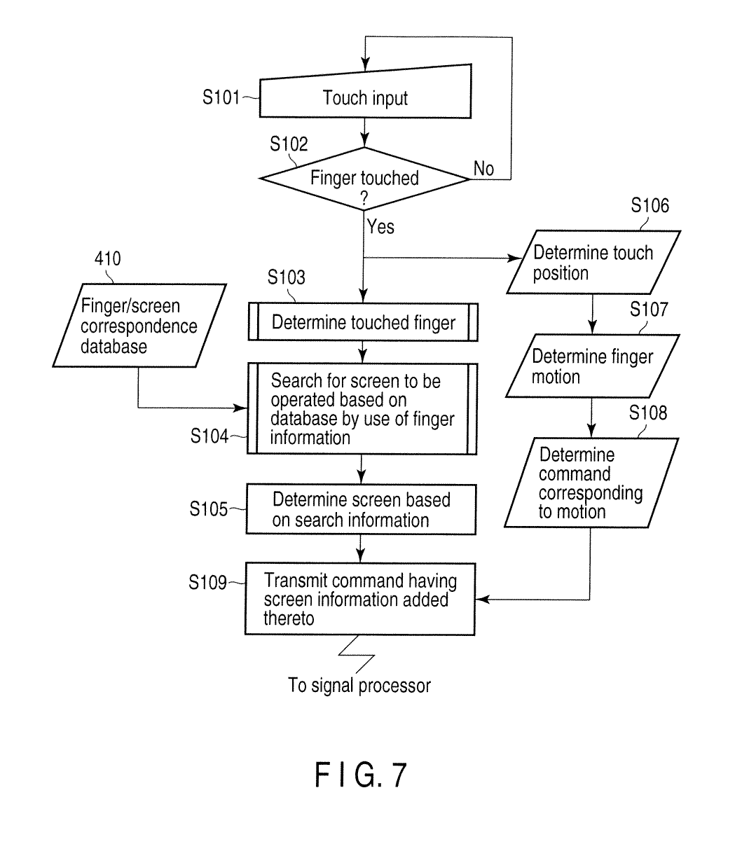

Next, one example of the concrete example of the screen operation process according to this invention is explained with reference to the flowchart of FIG. 7.

When a division instruction is received from the user via the remote controller 32, the signal processor 15 divides the screen of the display unit 23a as shown in FIG. 4 or FIG. 5. The touch finger determination unit 210 of the remote controller 32 determines whether or not a finger touches the touch input unit 100 (S101. S102). If the finger touches the touch input unit 100, it determines what one of the fingers is touched (S103). The finger determining process is performed by pattern matching between fingerprint information of the fingers of the user that are previously registered and a fingerprint of the finger now touching the touch input unit 100, for example. The information of the thus determined finger (touch finger information) is transmitted to the screen decision unit 400.

The screen decision unit 400 searches the finger/screen correspondence database 410 by use of touch finger information (S104) to determine a screen to be operated (S105).

In parallel with the above screen determining process (S103 to S105), the finger position determination unit 200 determines the touch position of the finger that now touches the touch input unit 100 and transmits the determination result to the finger/motion storage unit 300 (S106). The finger/motion storage unit 300 sequentially stores touch positions received to determine the motion (motion trajectory) of the finger touching portion (S107). The command determination unit 320 searches the motion•command database by use of the determined motion to determine a command corresponding to the motion (S108).

The command transmission unit 500 creates command information having screen information from the screen decision unit 400 added to a command from the command determination unit 320 and transmits the information to the signal processor 15. The signal processor 15 performs a process corresponding to a command of channel switching, for example, for a specified screen among a plurality of screens displayed on the display unit 23a based on the received command information.

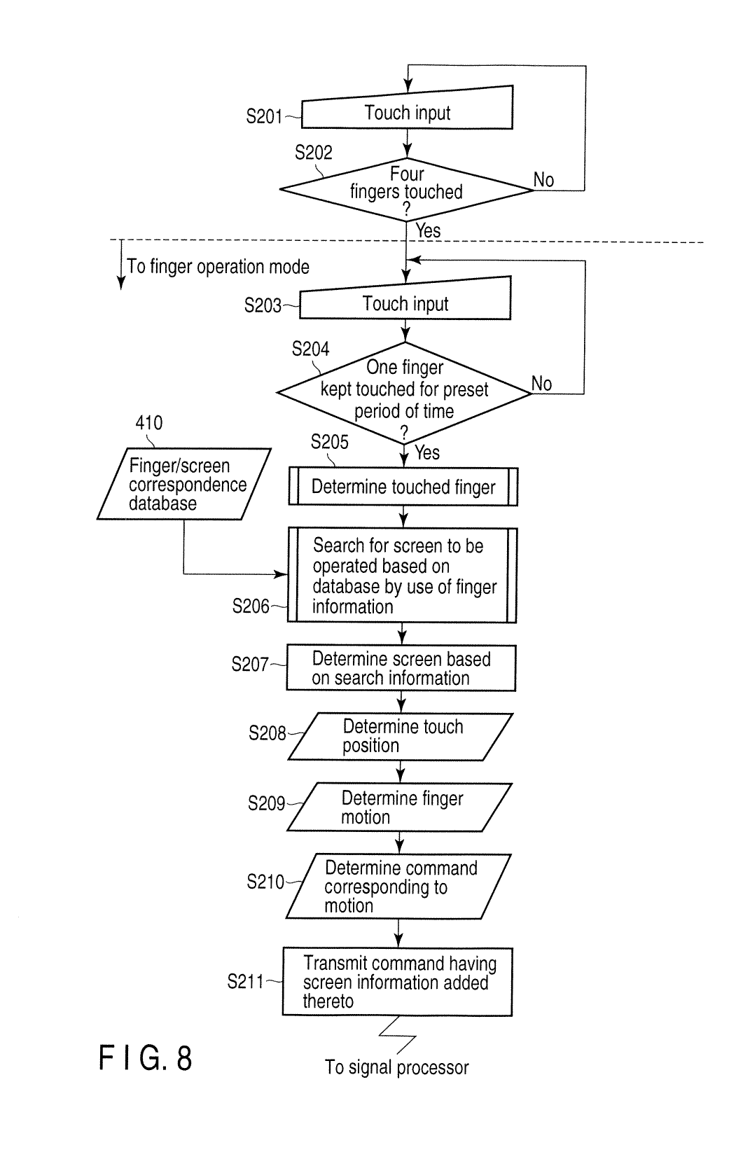

Next, a second embodiment of the concrete operation of a screen operation process according to this invention is explained with reference to the flowchart of FIG. 8. In the first embodiment, the finger touch determining process of the touch finger determination unit 210 and the finger position determining process of the finger position determination unit 200 are performed in parallel (simultaneously). However, in the second embodiment, the finger position determining process is performed after a to-be-operated screen is determined based on the touch finger determining process. Next, the second embodiment is explained in detail for the operation of a multi-screen obtained by dividing a screen into four portions as shown in FIG. 4 or FIG. 5. The number of divisions is set to two or more and can be freely selected by the user.

When a division instruction is received from the user via a remote controller 32, a signal processor 15 divides a screen of a display unit 23a as shown in FIG. 4 or FIG. 5. A touch finger determination unit 210 of the remote controller 32 detects that a plurality of fingers have touched. Then, if the fingers among the plural fingers other than the finger to be operated are separated, the finger that is left touched is determined as a finger to be touched, that is, a finger to be used for operation. At this time, it may be determined that the finger is separated without fail a preset period of time after the finger has been separated by taking a case wherein the finger is unintentionally separated into consideration. For example, the touch finger determination unit 210 determines whether or not the four fingers corresponding in number to the screens have touched the touch input unit 100 as shown in FIG. 8 (S201, S202). If the four fingers have touched the touch input unit 100, the touch finger determination unit 210 stores the positions of the four finger touch portions and is set into a finger operation mode. The touch finger determination unit 210 determines whether or not only one finger is kept touched for a preset period of time (S203, S204) in the finger operation mode.

If one finger is kept touched for a preset period of time (Yes in S204), the touch finger determination unit 210 determines the finger that is kept touched (S205). The finger determining process is performed based on a correspondence relationship between the touch positions of the four fingers stored in step S202 and the present finger touch position. For example, if the second finger from the right side of the four finger touch positions is kept touched with the touch input unit 100, the touch finger determination unit 210 determines the finger now touched as a middle finger. Information of the thus determined finger (touch finger information) is transmitted to a screen decision unit 400. When the fingers are separated, a finger to be operated is determined as a finger to be used for operation if the finger is immediately returned and touched even in a case where the finger to be operated is separated together with the other fingers.

The screen decision unit 400 searches a finger/screen correspondence database 410 by use of touch finger information (S206) to determine a screen to be operated (S207).

Next, a finger position determination unit 200 determines the touch position of a finger that now touches the touch input unit 100 and transmits the determination result to a finger/motion storage unit 300 (S208). After the screen to be operated is determined, any type of the finger that touches the touch input unit 100 is permitted.

The finger/motion storage unit 300 decides the motion of the finger touch portion by sequentially storing the received finger touch positions (S209). A command determination unit 320 searches a motion•command database based on the thus decided motion to determine a command corresponding to the motion (S210).

A command transmission unit 500 creates command information having screen information from the screen decision unit 400 added to a command from the command determination unit 320 and transmits the information to the signal processor 15. The signal processor 15 performs a process corresponding to a command of channel switching, for example, for a specified screen among a plurality of screens displayed on the display unit 23a based on the received command information.

The above explanation is made for the embodiments of this invention and does not limit the apparatus and method of this invention and various modifications can be easily made. For example, the fingers are not simply assigned to the screens but the type of a command to be transmitted to a screen may be determined based on a combination of the types of motions/fingers to perform a more complicated operation.

For example, a plurality of fingers may be simultaneously processed. That is, in the first embodiment, it is possible to simultaneously operate the screens B and C if the middle finger and third finger are simultaneously moved. Alternatively, if six or more screens are provided, a screen may be selected according to a combination of plural fingers. For example, in the first embodiment, if the index finger and middle finger are simultaneously touched, it is possible to select a screen 6.

Further, the function block that is provided on the television side and related to the command determination unit and/or screen decision unit may be set on the remote controller side. On the other hand, the finger position determination unit and/or touch finger determination unit provided on the remote controller side may be moved to the television side.

[Effect]

The operation can be more rapidly performed in comparison with a conventional case wherein a screen is specified and then the operation (channel switching, input switching, main/sub screen switching or the like) is performed for the screen.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a touch input module configured to detect a position of a touch portion with a finger,
a storage configured to store a trajectory of the touch portion that moves,
a command determination module configured to determine a command corresponding to the trajectory,
a finger type determination module configured to determine a type of a finger that touches the touch input module,
a finger/screen database in which ones of divided screens are set in correspondence to the respective fingers,
a decision module configured to search the database and decide a screen that corresponds to the type of the finger determined by the determination module,
a control module configured to control display of the respective ones of the divided screens of an input control signal, and
a transmitter configured to add information of the screen decided by the decision module to the command determined by the determination module and transmit the result as the control signal to the control module.

2. The information processing apparatus of claim 1, wherein detection of the position of the touch portion by the touch input module, storage of the trajectory by the storage module and command determination by the determination module are performed in parallel with determination of the type by the determination module and screen decision by the decision module.

3. The information processing apparatus of claim 1, wherein determination of the type by the determination module, screen decision by the decision module, detection of the position of the touch portion by the touch input module, storage of the trajectory by the storage module and command determination by the determination module are performed in the above order.

4. The information processing apparatus of claim 3, wherein the finger type determination module detects that a plurality of fingers have touched and determines that a finger corresponding to at least one of a plurality of touch portions is a finger used for operation if the fingers are separated from the touch portions other than the at least one of the plurality of touch portions.

5. The information processing apparatus of claim 3, wherein the finger type determination module detects that a plurality of finger touch portions corresponding in number to screens in the divided screens are present in the touch input module and if only one touch portion is detected, determines a type of the finger that touches the one touch portion based on the relative position of the one touch portion in the plurality of touch portions.

6. The information processing apparatus of claim 1, further comprising a display configured to display the divided screens.

7. The information processing apparatus of claim 1, wherein the command determination module determines a trajectory in a vertical direction as channel switching and determines a trajectory in a horizontal direction as switching of video devices connected to the apparatus.

8. An information processing apparatus that receives position information indicating a position of a touch portion and touch finger information indicating a type of a finger from a remote controller including a touch input module configured to detect the position of the touch portion with the finger and a determination module configured to determine the type of the finger that touches the touch input module, comprising:
a storage configured to store a trajectory of the touch portion that moves based on the position information,
a determination module configured to determine a command corresponding to the trajectory,
a finger/screen database in which ones of divided screens are set in correspondence to the respective fingers,
a decision module configured to search the database based on the touch finger information and decide a screen that corresponds to the type of the finger,
a control module configured to control display of the respective ones of the divided screens of an input control signal, and
a transmitter configured to add information of the screen decided by the decision module to the command determined by the determination module and transmit the result as the control signal to the control module.

9. The information processing apparatus of claim 8, wherein detection of the position of the touch portion by the touch input module, storage of the trajectory by the storage and command determination by the determination module are performed in parallel with determination of the type by the determination module and screen decision by the decision module.

10. The information processing apparatus of claim 8, wherein determination of the type by the determination module, screen decision by the decision module, detection of the position of the touch portion by the touch input module, storage of the trajectory by the storage and command determination by the determination module are serially performed in the above order.

11. An information processing method comprising:
detecting a position of a touch portion with a finger by use of a touch panel,
storing a trajectory of the touch portion that moves,
determining a command corresponding to the trajectory,
determining a type of a finger that touches the touch panel,
searching a finger/screen database in which ones of divided screens are set in correspondence to the respective fingers and deciding a screen that corresponds to the type of the finger determined,
adding information of the decided screen to the determined command and transmitting the result as a control signal, and
controlling display of the respective ones of the divided screens of the control signal.

12. The information processing method of claim 11, wherein detection of the position of the touch portion with the finger, storage of the trajectory and command determination are performed in parallel with determination of the type and screen decision.

13. The information processing method of claim 11, wherein the determining the type of the finger is detecting that a plurality of fingers have touched and determining that a finger corresponding to at least one of a plurality of touch portions is a finger used for operation if the fingers are separated from the touch portions other than the at least one of the plurality of touch portions.

14. The information processing method of claim 12, wherein the determining the type of the finger is detecting that a plurality of finger touch portions corresponding in number to screens in the divided screens are present in the touch input module and if only one touch portion is detected, determining a type of the finger that touches the one touch portion based on the relative position of the one touch portion in the plurality of touch portions.
